(19) United States
(12) Patent Application Publication
(10) Pub. No.: US 2024/0093707 A1
(43) Pub. Date: Mar. 21, 2024

(54) FASTENING BODY

(71) Applicant: TING-JUI WANG, New Taipei City (TW)

(72) Inventor: TING-JUI WANG, New Taipei City (TW)

(21) Appl. No.: 18/464,292

(22) Filed: Sep. 11, 2023

(30) Foreign Application Priority Data
Sep. 15, 2022 (TW) 111134835

(51) Int. Cl. F16B 5/02

(52) U.S. Cl. CPC F16B 5/0266

(57) ABSTRACT

A fastening body and an application method thereof include a locking part, an elastic element and a blocking section. The blocking section is movably disposed at the locking part. The elastic element is disposed between the locking part and the blocking section, and the blocking section cooperates with the elastic element to apply an elastic pressure to an engaged object. Accordingly, the fastening body and the application method thereof can provide the required object and the engaged object to achieve a stable combination and have the effect of being shockproof.

### CROSS-REFERENCE TO RELATED APPLICATION

This non-provisional application claims priority under 35 U.S.C. § 119(a) on Patent Application No(s). 111134835 filed in Taiwan, R.O.C. on Sep. 15, 2022, the entire contents of which are hereby incorporated by reference.

### BACKGROUND OF THE INVENTION

### 1. Field of the Invention

The present disclosure relates to a fastening body and an application method thereof, and in particular to a fastening body and an application method thereof that can provide the required object and an engaged object to achieve a stable combination and have the effect of being shockproof.

### 2. Description of the Related Art

Generally, when combining at least one object, it is usually achieved by locking with buckles to combine the object, but it often occurs that the object is unstable and loose after combination because of the structural design of the buckle.

### BRIEF SUMMARY OF THE INVENTION

In view of the above prior art, the present disclosure provides a fastening body and an application method thereof, with a view to achieving the purpose of providing the required object and an engaged object to be firmly combined.

To achieve the above objective and other objectives, the present disclosure provides a fastening body, including a locking part, an elastic element and a blocking section. The blocking section is movably disposed at the locking part. The elastic element is disposed between the locking part and the blocking section, and the blocking section cooperates with the elastic element to apply an elastic pressure to an engaged object.

The present disclosure further provides a fastening body, including a locking part, an elastic element, a blocking section, and a fastener. The blocking section is movably disposed at the locking part, the elastic element is disposed between the locking part and the blocking section, the locking part is fastened with the fastener, so that the blocking section cooperates with the elastic element to apply an elastic pressure to an engaged object.

The present disclosure further provides an application method of a fastening body, the fastening body includes a locking part, an elastic element, and a blocking section. The blocking section is movably disposed at the locking part, the elastic element is disposed between the locking part and the blocking section, and the blocking section cooperates with the elastic element to apply an elastic pressure to an engaged object. The fastening body is assembled to an object, when assembled, the blocking section cooperates with the elastic element to apply an elastic pressure equal to or greater than an elastic stroke of a thickness of the blocking section to the engaged object, or when assembled, the blocking section cooperates with the elastic element to apply an elastic pressure equal to or greater than an elastic stroke of a thickness of a limiting part of the locking part to the engaged object, or when assembled, the blocking section cooperates with the elastic element to apply an elastic pressure equal to or greater than an elastic stroke of a thickness of the blocking section or plus a thickness of a limiting part of the locking part to the engaged object.

The present disclosure further provides an application method of a fastening body, the fastening body includes a locking part, an elastic element and a blocking section. The blocking section is movably disposed at the locking part, the elastic element is disposed between the locking part and the blocking section, and the blocking section cooperates with the elastic element to apply an elastic pressure to an engaged object. When the blocking section cooperates with the elastic element to apply an elastic pressure to the engaged object, the blocking section cooperates with the elastic element to apply an elastic pressure equal to or greater than an elastic stroke of a thickness of a limiting part of the locking part to the engaged object.

The present disclosure further provides an application method of a fastening body, the fastening body includes a locking part, an elastic element and a blocking section. The blocking section is movably disposed at the locking part, the elastic element is disposed between the locking part and the blocking section, and the blocking section cooperates with the elastic element to apply an elastic pressure to an engaged object. When the blocking section cooperates with the elastic element to apply an elastic pressure to the engaged object, the blocking section cooperates with the elastic element to apply an elastic pressure equal to or greater than an elastic stroke of a thickness of the blocking section to the engaged object.

The present disclosure further provides an application method of a fastening body, the fastening body includes a locking part, an elastic element and a blocking section. The blocking section is movably disposed at the locking part, the elastic element is disposed between the locking part and the blocking section, and the blocking section cooperates with the elastic element to apply an elastic pressure to an engaged object. When the blocking section cooperates with the elastic element to apply an elastic pressure to the engaged object, the blocking section cooperates with the elastic element to apply an elastic pressure equal to or greater than an elastic stroke of a thickness of a limiting part of the locking part plus a thickness of the blocking section to the engaged object.

The present disclosure further provides an application method of a fastening body, the fastening body includes a locking part, an elastic element, and a blocking section. The blocking section is movably disposed at the locking part, the elastic element is disposed between the locking part and the blocking section, and the blocking section cooperates with the elastic element to apply an elastic pressure to an engaged object. When the engaged object is used to vertically or laterally fasten, enter or squeeze, the blocking section cooperates with the elastic element to apply an elastic pressure equal to or greater than an elastic stroke of a thickness of the blocking section or equal to or greater than an elastic stroke of a thickness of a limiting part of the locking part to the engaged object, or apply an elastic pressure equal to or greater than an elastic stroke of a thickness of the blocking section or plus a thickness of a limiting part of the locking part to the engaged object.

The present disclosure further provides an application method of a fastening body, the fastening body includes a locking part, an elastic element and a blocking section. The blocking section is movably disposed at the locking part, the elastic element is disposed between the locking part and the blocking section, and the blocking section cooperates with the elastic element to apply an elastic pressure to a engaged object; among them, the blocking section and an object or a fastener therebetween have a reserved height, the engaged object is horizontally or vertically fastened into, entering or squeezed into the locking part from the reserved height, and the blocking section is used to apply an elastic pressure to the engaged object.

The present disclosure further provides an application method of a fastening body, the fastening body includes a locking part, an elastic element, and a blocking section. The blocking section is movably disposed at the locking part, the elastic element is disposed between the locking part and the blocking section, and the blocking section cooperates with the elastic element to apply an elastic pressure to an engaged object. The blocking section and an object or a fastener therebetween have a reserved height, the engaged object is horizontally or vertically fastened into, entering or squeezed into the locking part from the reserved height, the reserved height is greater than or equal to a height of the engaged object, or the reserved height is greater than or equal to a height of a limiting part, or the reserved height is less than the height of the engaged object.

The present disclosure further provides an application method of a fastening body, the fastening body includes a locking part, an elastic element and a blocking section. The blocking section is movably disposed at the locking part, the elastic element is disposed between the locking part and the blocking section, and the blocking section cooperates with the elastic element to apply an elastic pressure to an engaged object. After the fastening body is combined with a fastener, the blocking section and the fastener therebetween have a reserved height, after the fastener is assembled to an object, the engaged object is horizontally or vertically fastened into, entering or squeezed into the locking part from the reserved height, and the blocking section is used to apply an elastic pressure to the engaged object.

In the above fastening body, the locking part is provided with a limiting part, the limiting part is used to limit a position with the blocking section, or the locking part is fastened with the fastener and limits a position by the limiting part, or a width of the limiting part is wider than or equal to a width of the locking part, or the width of the limiting part is wider than a width of a corresponding abutting part of the blocking section.

In the above fastening body and application method thereof, the locking part is provided with a restriction part, and the restriction part is used to combine with the fastener.

In the above fastening body and application method thereof, the fastener and the blocking section therebetween have a reserved height, after the engaged object is horizontally or vertically fastened into, entering or squeezed into the locking part from the reserved height, and the blocking section is used to apply an elastic pressure to the engaged object.

In the above fastening body and application method thereof, the blocking section and an object or a fastener therebetween have a reserved height, after the engaged object is fastened into, entering or squeezed into the locking part from the reserved height, the reserved height is lowered or a height of the locking part is lowered, and the blocking section is used to apply an elastic pressure to the engaged object.

In the above fastening body and application method thereof, the engaged object is provided with an entry portion and an engagement portion communicated with each other, the fastening body enters the engagement portion from the entry portion, so that the blocking section elastically contacts to the engaged object, and then the locking part fastens with the fastener, so that the blocking section applies an elastic pressure to the engaged object.

In the above fastening body and application method thereof, the engaged object is provided with an engagement portion, the engagement portion is a hole or groove part.

In the above fastening body and application method thereof, the locking part, an engagement portion, or a fastener is a threaded part, an outer fastening body, an inner fastening body, a bolt body, a cylinder body, or an elastic fastening body.

In the above fastening body and application method thereof, the locking part is provided with a head.

In the above fastening body and application method thereof, the fastener is provided with an assembling portion, the assembling portion is assembled to an object, or the assembling portion is for soldering, fastening, riveting, expanding, locking, or bonding to an object.

In the above fastening body and application method thereof, the fastening body is assembled to an object, so that the blocking section cooperates with the elastic element to apply an elastic pressure to the engaged object. The object or the engaged object is a PCB, a heat dissipation body, a metal body, or a plastic body.

In the above fastening body and application method thereof, the fastening body is assembled to an object, when assembled, the blocking section cooperates with the elastic element to apply an elastic pressure greater than or equal to an elastic stroke of a thickness of a limiting part of the locking part to the engaged object.

In the above fastening body and application method thereof, the blocking section is a fastener, the fastener is used to fasten to the engaged object, or the blocking section is provided with a fastener, and the fastener is used to fasten to the engaged object.

In the above fastening body and application method thereof, the locking part is provided with a locking part assembling portion. The locking part assembling portion is assembled to an object. The locking part assembling portion is provided with a first anti-rotation part, the object is provided with an object anti-rotation part, the first anti-rotation part and the object anti-rotation part are anti-rotated or limited to each other, or for limiting a fastening direction of the locking part assembling portion or for limiting a fastening direction of the blocking section.

In the above fastening body and application method thereof, the locking part is provided with a locking part assembling portion. The locking part assembling portion is assembled to an object, wherein the locking part assembling portion has a material entry portion to make the material of the object flow into or enter the material entry portion when the locking part applies pressure to the object, or the locking part assembling portion has an expanding portion for expanding and connecting to the object, or the locking part assembling portion has a solderable surface for soldering to the object, or the locking part assembling portion has a locking part for fastening to the object, or the locking part assembling portion has a screw thread for screw fastening to the object.

In the above fastening body and application method thereof, the locking part is provided with a second anti-rotation part, the blocking section is provided with a blocking section anti-rotation part, the second anti-rotation part and the blocking section anti-rotation part are anti-rotated or limited to each other, or for limiting the fastening direction of the blocking section.

In the above fastening body and application method thereof, the blocking section is used to rotate after resisting an elastic movement of the elastic element by a engaged object, or the blocking section rotates after resisting an elastic movement of the elastic element, so that the blocking section is fastened or pressed to the engaged object.

In the above fastening body and application method thereof, the blocking section is provided with a blocking section limiting part, and the engaged object has an engaged object limiting part docking with the blocking section limiting part.

In the above fastening body and application method thereof, the locking part or the blocking section is provided with an operating part.

In the above fastening body and application method thereof, the engaged object or an object is a PCB, a heat dissipation body, IC, a chip, a metal member, or a plastic member.

In the above fastening body and application method thereof, the locking part applies an elastic pressure to the engaged object by the elastic element.

In the above fastening body and application method thereof, the fastening body is assembled to an object. When assembled, the blocking section cooperates with the elastic element to apply an elastic pressure equal to or greater than an elastic stroke of a thickness of the blocking section to the engaged object, or when assembled, the blocking section cooperates with the elastic element to apply an elastic pressure equal to or greater than an elastic stroke of a thickness of a limiting part of the locking part to the engaged object, or when assembled, the blocking section cooperates with the elastic element to apply an elastic pressure equal to or greater than an elastic stroke of a thickness of the blocking section or plus a thickness of a limiting part of the locking part to the engaged object.

Accordingly, the fastening body and the application method thereof of the present disclosure can provide the required object and the engaged object to achieve a stable combination and have the effect of being shockproof.

### BRIEF DESCRIPTION OF THE DRAWINGS

FIG. 1 is a schematic view of a side-view state of a fastening body of an embodiment of the present disclosure.

FIG. 2 is a schematic view of an operating state of the fastening body of an embodiment of the present disclosure.

FIG. 3 is a schematic view 1 of an operating state of the fastening body of an embodiment of the present disclosure.

FIG. 4 is a schematic view 2 of an operating state of the fastening body of an embodiment of the present disclosure.

FIG. 5 is a schematic view of an operating state of the fastening body of an embodiment of the present disclosure.

FIG. 6 is a schematic view of a first assembly state of the fastening body of an embodiment of the present disclosure.

FIG. 7 is a schematic view of a second assembly state of the fastening body of an embodiment of the present disclosure.

FIG. 8 is a schematic view of a third assembly state of the fastening body of an embodiment of the present disclosure.

FIG. 9 is a schematic view of a fourth assembly state of the fastening body of an embodiment of the present disclosure.

FIG. 10 is a schematic perspective view of the fastening body of a fifth embodiment of an embodiment of the present disclosure.

FIG. 11 is a schematic view of an operating state of the fastening body of an embodiment of the present disclosure.

FIG. 12 is a schematic view of a side-view state of the fastening body of an embodiment of the present disclosure.

FIG. 13 is a schematic view of a top-view state of the fastening body of an embodiment of the present disclosure.

FIG. 14 is a schematic view 1 of a side-view state of the fastening body of an embodiment of the present disclosure.

FIG. 15 is a schematic view 2 of the side-view state of the fastening body of an embodiment of the present disclosure.

FIG. 16 is a schematic view of a top-view state of the fastening body of an embodiment of the present disclosure.

FIG. 17 is a schematic perspective view of the fastening body of an embodiment of the present disclosure.

FIG. 18 is a schematic view of a top-view state of the fastening body of an embodiment of the present disclosure.

### DETAILED DESCRIPTION OF THE INVENTION

To facilitate understanding of the purpose, characteristics and effects of the present disclosure, embodiments together with the attached drawings for the detailed description of the present disclosure are provided as below.

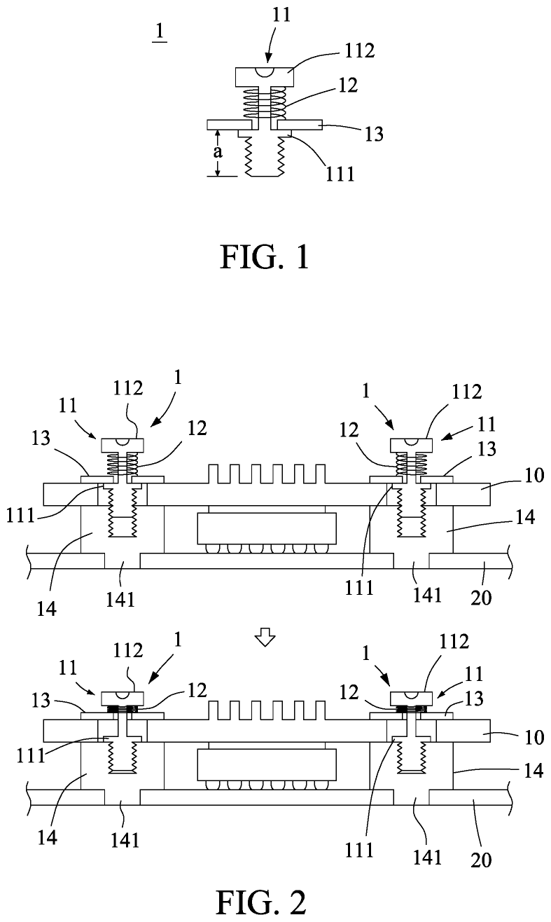

Referring to FIGS. 1 and 2, the present disclosure is a fastening body and an application method thereof, the fastening body 1 includes a locking part 11, an elastic element 12 and a blocking section 13. The blocking section 13 is movably disposed at the locking part 11. The elastic element 12 is disposed between the locking part 11 and the blocking section 13, and two ends of the elastic element 12 are respectively abutted against the locking part 11 and the blocking section 13. The blocking section 13 cooperates with the elastic element 12 to apply an elastic pressure to an engaged object 10.

In the application method of the fastening body of the present disclosure, when the blocking section 13 cooperates with the elastic element 12 to apply an elastic pressure to the engaged object 10, the blocking section 13 cooperates with the elastic element 12 to apply an elastic pressure equal to or greater than an elastic stroke of a thickness of the blocking section 13 to the engaged object 10.

In an embodiment of the present disclosure, the fastening body may further include a fastener 14, and the locking part 11 may cooperate with the fastener 14 to perform engagement according to the needs of practical application, or not use the fastener 14.

When used, the fastener 14 may be disposed on an object 20, and the engaged object 10 is disposed between the blocking section 13 and the fastener 14. Then, the locking part 11 is rotated so that the locking part 11 is engaged with the fastener 14. The blocking section 13 cooperates with the elastic element 12 to apply an elastic pressure to the engaged object 10, and then the blocking section 13 is pressed against the engaged object 10. Thus, the fastening body 1 can provide the object 20 and the engaged object 10 to achieve a stable combination and have the effect of being shockproof.

In an embodiment of the present disclosure, the locking part 11 is provided with a limiting part 111. The limiting part 111 may be used to limit a position with the blocking section 13, or the locking part 11 is engaged with the fastener 14 and limits a position by the limiting part 111, or a width of the limiting part 111 is wider than or equal to a width of the locking part 11, or the width of the limiting part 111 is wider than a width of a corresponding abutting part (not shown) of the blocking section 13.

In an embodiment of the present disclosure, when assembled, the blocking section 13 cooperates with the elastic element 12 to apply an elastic pressure equal to or greater than an elastic stroke of a thickness of the limiting part 111 of the locking part 11 to the engaged object 10, or when assembled, the blocking section 13 cooperates with the elastic element 12 to apply an elastic pressure equal to or greater than an elastic stroke of the thickness of the blocking section 13 or plus the thickness of the limiting part 111 of the locking part 11 to the engaged object 10.

In an embodiment of the present disclosure, when the blocking section 13 cooperates with the elastic element 12 to apply an elastic pressure to the engaged object 10. The blocking section 13 cooperates with the elastic element 12 to apply an elastic pressure equal to or greater than an elastic stroke of the thickness of the limiting part 111 to the engaged object 10.

In an embodiment of the present disclosure, when the blocking section 13 cooperates with the elastic element 12 to apply an elastic pressure to the engaged object 10, the blocking section 13 cooperates with the elastic element 12 to apply an elastic pressure equal to or greater than an elastic stroke of a thickness of a limiting part 111 of the locking part 11 plus the thickness of the blocking section 13 to the engaged object 10.

In an embodiment of the present disclosure, the fastening body 1 is assembled to the object 20, and when vertically assembled, the blocking section 13 cooperates with the elastic element 12 to apply an elastic pressure equal to or greater than an elastic stroke of the thickness of the blocking section 13 or equal to or greater than an elastic stroke of the thickness of the limiting part 111 to the engaged object 10, or apply an elastic pressure equal to or greater than an elastic stroke of the thickness of the blocking section 13 or plus the thickness of the limiting part 111 to the engaged object 10.

In an embodiment of the present disclosure, the locking part 11 is provided with a head 112. The two ends of the elastic assembly 12 are respectively abutted against the head 112 and the blocking section 13. The head 112 may be used as applying force when operating the locking part 11, thereby applying force to the head 112 and rotating the locking part 11, so that the locking part 11 is fastened with the fastener 14. The blocking section 13 cooperates with the elastic element 12 to apply an elastic pressure to the engaged object 10, and then the blocking section 13 is pressed against the engaged object 10. Thus, the fastening body 1 can provide the object 20 and the engaged object 10 to achieve a stable combination and have the effect of being shockproof.

In an embodiment of the present disclosure, the fastener 14 is provided with an assembling portion 141, the assembling portion 141 is assembled to the object 20, or the assembling portion 141 is for soldering, fastening, riveting, expanding, locking or bonding to an object. Thus, the fastener 14 may be securely combined with the object 20 by the assembling portion 141.

In an embodiment of the present disclosure, the engaged object 10 and the object 20 may be a PCB, a heat dissipation body, a metal body, or a plastic body. Thus, the fastening body 1 may be applied to the required engaged object 10 and the object 20.

In an embodiment of the present disclosure, the fastening body 1 is assembled to the object 20, and when assembled, the blocking section 13 cooperates with the elastic element 12 to apply an elastic pressure greater than (or equal to) an elastic stroke of the thickness of the limiting part 111 of the locking part 11 to the engaged object 10.

In an embodiment of the present disclosure, the locking part 11 or the fastener 14 may be a threaded part, an outer fastening body, an inner fastening body, a bolt body, a cylinder body, or an elastic fastening body according to the needs. Thus, the locking part 11 can meet the needs of various assembling requirements.

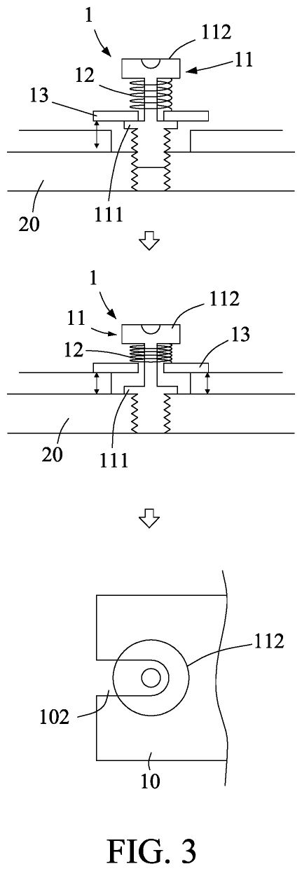

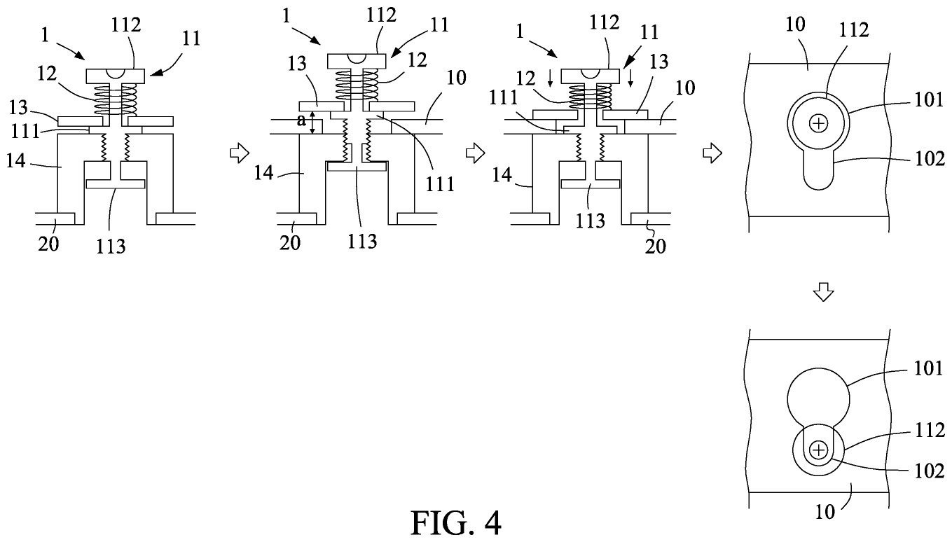

As shown in FIGS. 3 and 4, in an embodiment of the present disclosure, it differs from the above embodiments in that the locking part 11 is provided with a restriction part 113. The restriction part 113 is used to combine with the fastener 14. Thus, the restriction part 113 may be provided to firmly combine the locking part 11 and the fastener 14 (as shown in FIG. 4).

In an embodiment of the present disclosure, the blocking section 13 and the object 20 or the fastener 14 therebetween have a reserved height a. After the engaged object 10 is horizontally or vertically fastened into (entering or squeezed into) the locking part 11 from a space of the reserved height a, the reserved height a is lowered or a height of the locking part 11 is lowered. Then the blocking section 13 may cooperate with the elastic element 12 to apply an elastic pressure to the engaged object 10 (as shown in FIGS. 3 and 4), or the reserved height a is greater than (or equal to) the thickness of the limiting part 111 of the locking part 11, so that the fastening body 1 provides the object 20 and the engaged object 10 to achieve a stable combination and has the effect of being shockproof.

In an embodiment of the present disclosure, when the engaged object 10 is horizontally or vertically fastened in (entering or squeezed into) the locking part 11 from the reserved height a, the reserved height a is greater than or equal to a height of the engaged object 10, or the reserved height a is greater than or equal to a height of the limiting part 111, or the reserved height a is less than the height of the engaged object 10.

In an embodiment of the present disclosure, the engaged object 10 is provided with an entry portion 101 and an engagement portion 102 communicated with each other. The fastening body 1 enters the engagement portion 102 from the entry portion 101 by the head 112, so that the blocking section 13 elastically contacts (only contacts but has not yet applied an elastic pressure) to the engaged object 10, and then the locking part 11 fastens with the fastener 14, so that the blocking section 13 cooperates with the elastic element 12 to apply an elastic pressure to the engaged object 10 (as shown in FIG. 4).

In an embodiment of the present disclosure, the engagement portion 102 may be a threaded part, an outer fastening body, an inner fastening body, a bolt body, a cylinder body, or an elastic fastening body according to the needs.

In an embodiment of the present disclosure, the engaged object 10 may be provided with only one engagement portion 102. The engagement portion 102 may be a hole or groove part. The fastening body 1 is fastened to the engaged object 10 by the locking part 11, when the engaged object 10 is assembled to the fastening body 1 to let the fastening body 1 enter the engagement portion 102 by the head 112, so that the blocking section 13 cooperates with the elastic element 12 to apply an elastic pressure to the engaged object 10 (as shown in FIG. 3).

In an embodiment of the present disclosure, the fastening body 1 is assembled to the object 20. When assembled laterally, the blocking section 13 cooperates with the elastic element 12 to apply an elastic pressure equal to or greater than an elastic stroke of the thickness of the blocking section 13 or equal to or greater than an elastic stroke of the thickness of the limiting part 111 to the engaged object 10, or apply an elastic pressure equal to or greater than an elastic stroke of the thickness of the blocking section 13 or plus the thickness of the limiting part 111 to the engaged object 10.

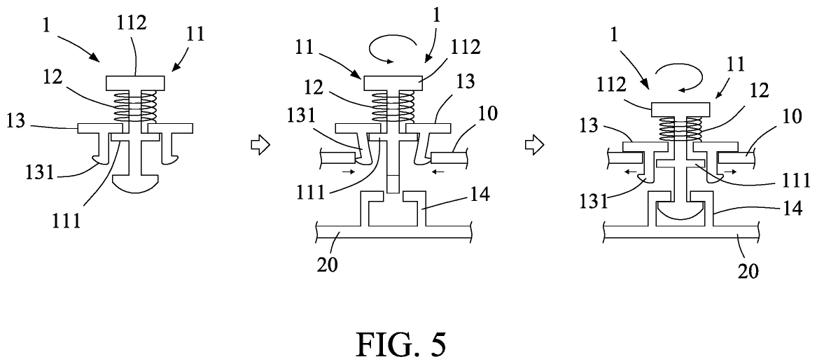

As shown in FIG. 5, in an embodiment of the present disclosure, it differs from the above embodiments in that the blocking section 13 is provided with a fastener element 131, the fastener element 131 is used to fasten to the engaged object (or the blocking section 13 is a fastener element, the fastener element is used to fasten to the engaged object 10), and the locking part 11 may be an outer fastening body. Thus, the locking part 11 can engage with the object 10, when the engaged object 10 is assembled to the fastening body 1, the fastener element 131 of the blocking section 13 is fastened with the engaged object 10, so that the present disclosure meets the needs of different fastening types.

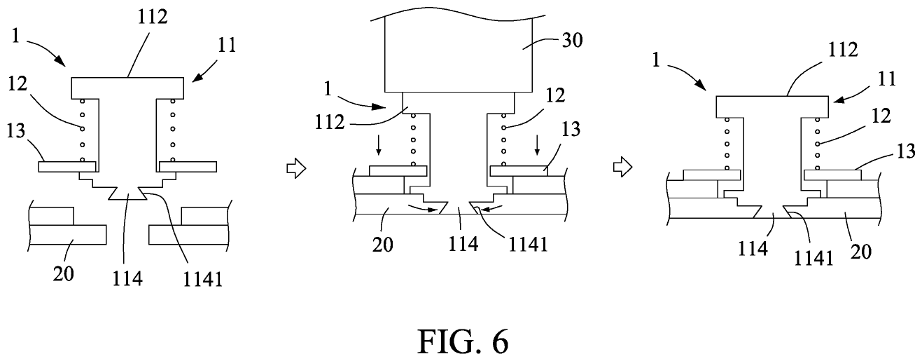

As shown in FIG. 6, in an embodiment of the present disclosure, the fastener 14 may not be used, and the locking part 11 is provided with a locking part assembling portion 114; and when the fastening body 1 and the object 20 are assembled, the locking part assembling section 114 may be disposed in the object 20, and an external force is exerted on the fastening body 1 by a mold 30 (such as the head 112 of the fastening body 1), so that the material flows into the locking part assembling section 114, and then the fastening body 1 and the object 20 are firmly combined to facilitate the subsequent assembly of the engaged object 10.

In an embodiment of the present disclosure, the locking part assembling section 114 has a material entry portion 1141 to make the material of the object 20 flow into or enter the material entry portion 1141 when the locking part 11 applies pressure to the object 20, and then the fastening body 1 and the object 20 are firmly combined to facilitate the subsequent assembly of the engaged object 10.

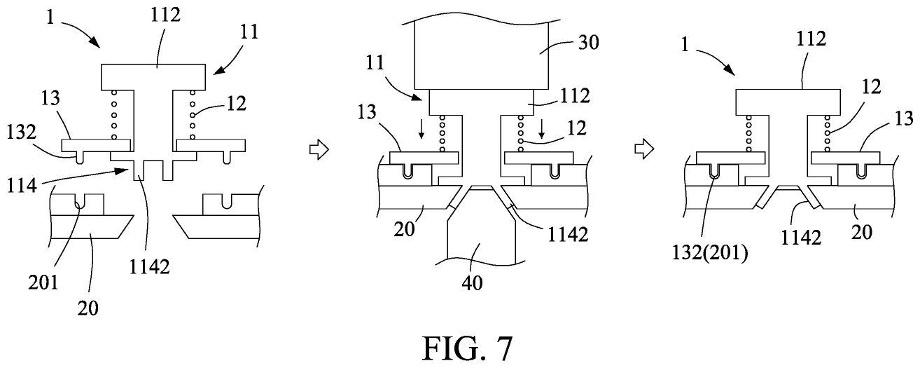

As shown in FIG. 7, in an embodiment of the present disclosure, the fastener 14 may not be used, and the locking part 11 is provided with a locking part assembling section 114, the locking part assembling section 114 may be an expanding structure; and when the fastening body 1 and the object 20 are assembled, the locking part assembling portion 114 may be disposed in the object 20, and external forces are exerted on the head 112 of the fastening body 1 and the locking part assembling portion 114 by two molds 30, 40, so that the fastening body 1 is expanded and connected to the object 20, and then the fastening body 1 and the object 20 are firmly combined to facilitate subsequent operation and use.

In an embodiment of the present disclosure, the locking part assembling portion 114 has an expanding portion 1142 for expanding and connecting to the object 10, and then the fastening body 1 and the object 20 are firmly combined to facilitate subsequent operation and use.

In an embodiment of the present disclosure, the blocking section 13 is provided with a blocking section limiting part 132, and the object 20 (or the engaged object 10) is provided with a corresponding limiting part 201, so that the fastening body 1 and the object 20 are firmly combined to facilitate subsequent operation and use.

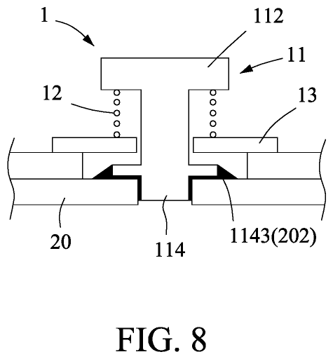

As shown in FIG. 8, in an embodiment of the present disclosure, the fastener 14 may not be used, and the locking part 11 is provided with a locking part assembling portion 114; and when the fastening body 1 and the object 20 are assembled, a tool (not shown) can be used to move the fastening body 1 to an assembly position of the object 20 by the head 112, and the locking part assembling portion 114 and the solder 202 of the object 20 are heated, so that the fastening body 1 is soldered to the object 20, and then the fastening body 1 and the object 20 are firmly combined to facilitate subsequent operation and use.

In an embodiment of the present disclosure, the locking part assembling portion 114 has a solderable surface 1143 for scolding to the object 10, and then the fastening body 1 and the object 20 are firmly combined to facilitate subsequent operation and use.

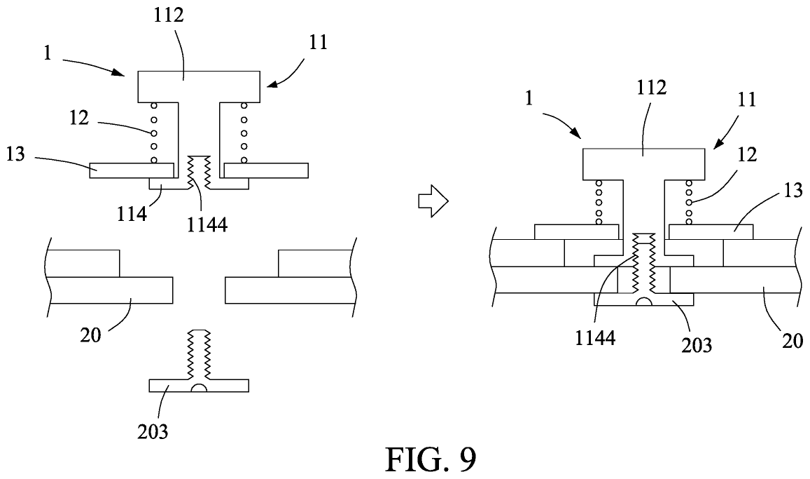

As shown in FIG. 9, in an embodiment of the present disclosure, the fastener 14 is not used, and the locking part 11 is provided with a locking part assembling portion 114, and the locking part assembling portion 114 may be a locking structure; and when the fastening body 1 and the object 20 are assembled, the fastening body 1 may be disposed in the assembly position of the object 20, and a locking member 203 and the locking part assembling portion 114 are locked to each other, so that the fastening body 1 is combined with the object 20, and then the fastening body 1 and the object 20 are firmly combined to facilitate subsequent operation and use.

In an embodiment of the present disclosure, the locking part assembling portion 114 has a screw locking part 1144 for screw fastening to the object 10, and then the fastening body 1 and the object 20 are firmly combined to facilitate subsequent operation and use.

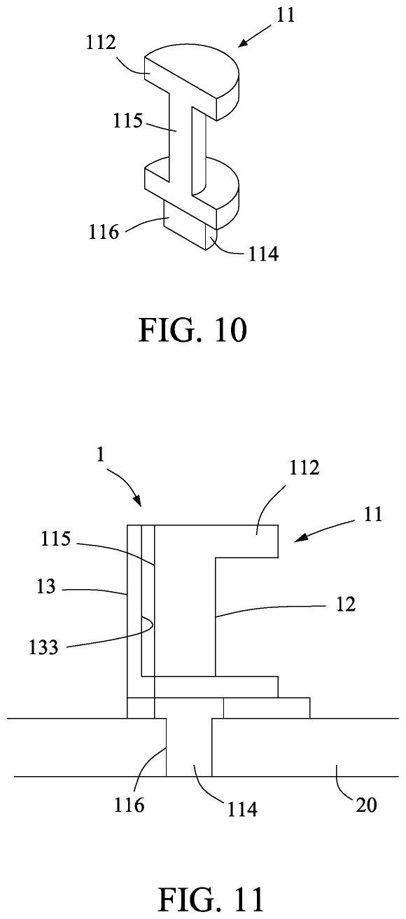

As shown in FIGS. 10 and 11, in an embodiment of the present disclosure, it differs from the above embodiments in that the locking part assembling portion 114 of the locking part 11 is assembled to the object 20, the locking part assembling portion 114 is provided with a first anti-rotation part 115, the object 20 is provided with an object anti-rotation part 204, the locking part 11 is provided with a second anti-rotation part 116, the blocking section 13 is provided with a blocking section anti-rotation part 133, wherein the first anti-rotation part 115 may be located below the second anti-rotation part 116. Thus, the first anti-rotation part 115 and the object anti-rotation part 204 may be anti-rotated or limited to each other (or for limiting a fastening direction of the locking part assembling portion 114 or for limiting a fastening direction of the blocking section 13), and the second anti-rotation part 116 and the blocking section anti-rotation part 133 are anti-rotated or limited to each other (or for limiting the fastening direction of the blocking section 13), and then the fastening body 1 and the object 20 are firmly assembled.

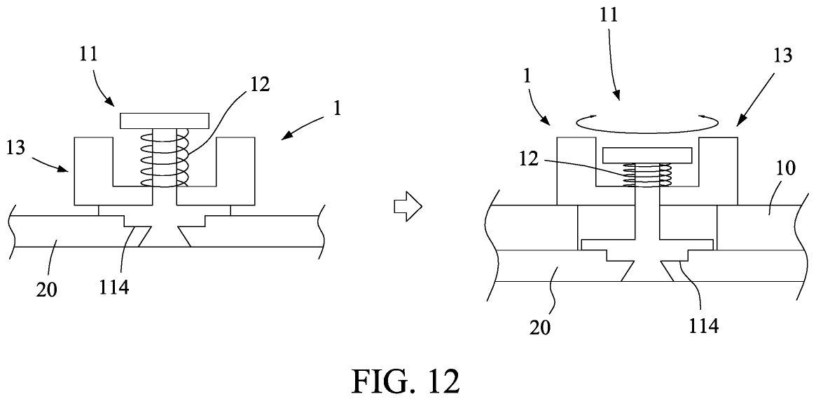

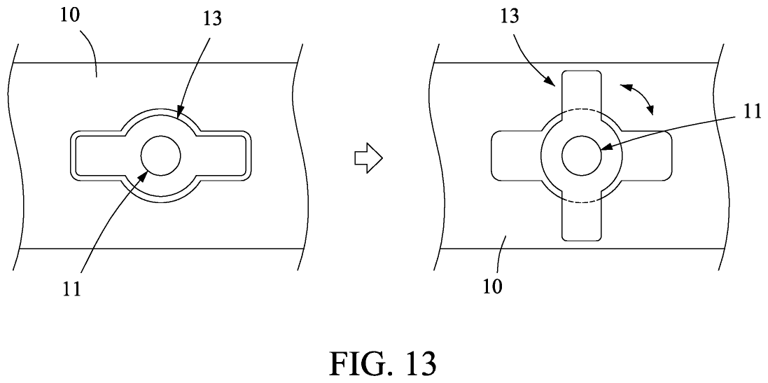

Referring to FIGS. 12 and 13, the fastening body 1 of the present disclosure, which comprises a locking part 11, a blocking section 13, and an elastic element 12, the blocking section 13 is movably disposed in the locking part 11, the elastic element 12 is disposed between the locking part 11 and the blocking section 13. The blocking section 13 is used to rotate after resisting an elastic movement of the elastic element 12 by an engaged object 10, or the blocking section 13 rotates after resisting an elastic movement of the elastic element 12, so that the blocking section 13 is fastened or pressed to the engaged object 10.

When used, the locking part 11 of the fastening body 1 may be disposed on an object 20, and the engaged object 10 is disposed on a surface of the object 20, and then the blocking section 13 is rotated to make the blocking section 13 rotate after resisting an elastic movement of the elastic element 12 by the engaged object 10, and then the blocking section 13 is fastened or pressed to the engaged object 10. Thus, the fastening body 1 can provide the object 20 and the engaged object 10 to achieve the effect of a stable combination.

In an embodiment of the present disclosure, the engaged object 10 and the object 20 may be a PCB, a heat dissipation body, IC, a chip, a metal member, or a plastic member; thus, the fastening body 1 and the required object may be combined to meet the needs.

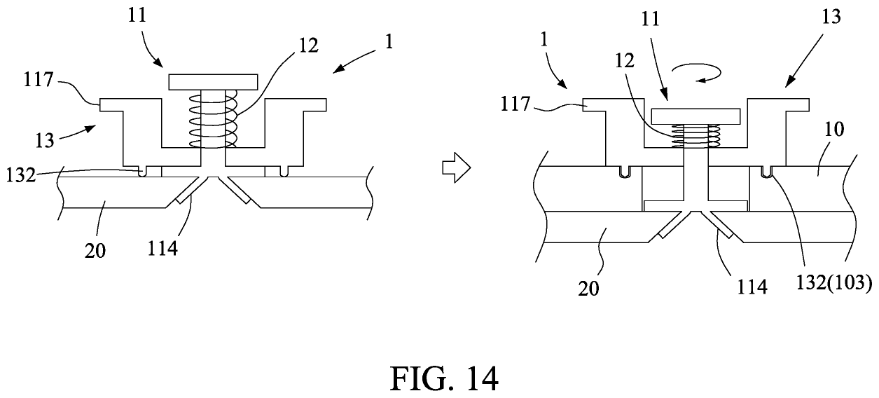

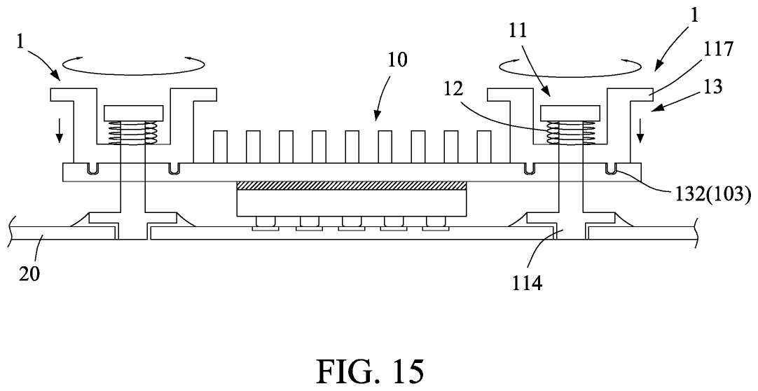

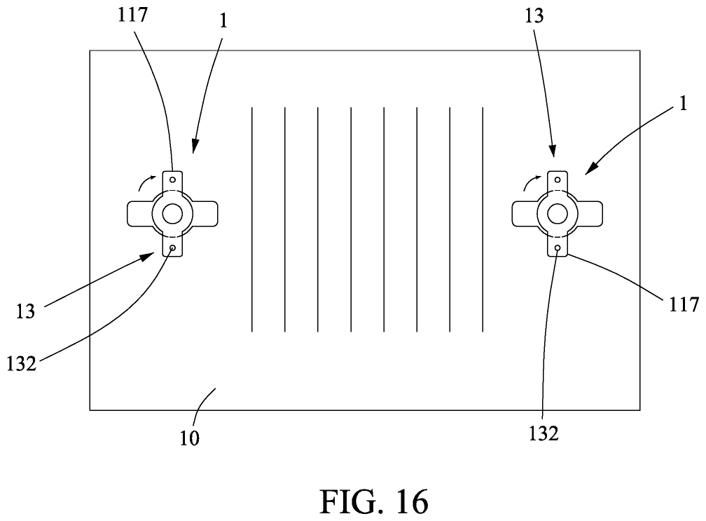

As shown in FIGS. 14 to 16, in an embodiment of the present disclosure, it differs from the above embodiments in that the blocking section 13 is provided with a blocking section limiting part 132, the engaged object 10 has an engaged object limiting part 103 docking with the blocking section limiting part 1132, and the locking part 11 (or the blocking section 13) is provided with an operating part 117.

Based on the above embodiment, the locking part assembling portion 114 of the locking part 11 may be disposed on the object 20 in an expanded manner, and the engaged object 10 may be disposed on a surface of the object 20, and then the blocking section 13 is rotated by the operating part 117, so that the elastic element 12 generates a contracted elastic force between the locking part 11 and the blocking section 13, and thus the locking part 11 rotates after resisting an elastic movement of the elastic element 12 by the engaged object 10, and then the blocking section limiting part 132 is correspondingly fastened or pressed to the engaged object limiting part 103 of the engaged object 10, and the blocking section 13 applies an elastic pressure to the engaged object 10 by the elastic element 12. Thus, the fastening body 1 can provide the object 20 and the engaged object 10 to achieve the effect of a stable combination.

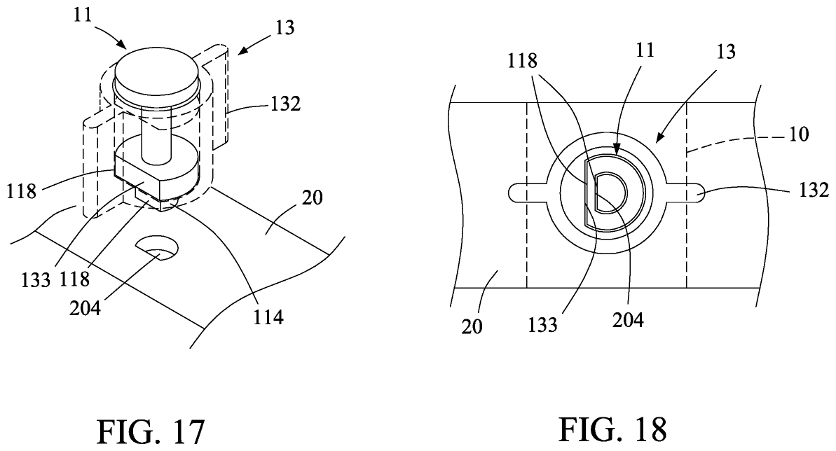

As shown in FIGS. 17 and 18, in an embodiment of the present disclosure, it differs from the above embodiments in that the blocking section 13 is provided with a blocking section anti-rotation part 133, the locking part 11 is provided with a locking part anti-rotation part 118, the blocking section anti-rotation part 133 and the locking part anti-rotation part 118 are used to correspondingly anti-rotate, or the blocking section anti-rotation part 133 and the locking part anti-rotation part 118 are used to correspondingly limit the fastening direction.

In an embodiment of the present disclosure, the object 20 is provided with an object anti-rotation part 204, the blocking section anti-rotation part 133 and the object anti-rotation part 204 are used to correspondingly anti-rotate, or the blocking section anti-rotation part 133 and the object anti-rotation part 204 are used to correspondingly limit the fastening direction.

Based on the above embodiment, when the locking part assembling portion 114 of the locking part 11 is assembled to the object 20, the blocking section anti-rotation part 133 and the object anti-rotation part 204 can be combined with each other and correspondingly anti-rotated, so as to limit the fastening direction of the locking part 11, and then the locking part 11 and the object 20 are firmly assembled.

Further, after the blocking section 13 rotates to fasten or press to the engaged object 10, the blocking section 13 is moved down, so that the locking part anti-rotation part 118 and the blocking section anti-rotation part 133 are combined with each other and correspondingly anti-rotated, thereby limiting the fastening direction of the blocking section 13, so that the blocking section 13 can firmly fasten the engaged object 10.

While the present invention has been described by means of specific embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. A fastening body, comprising a locking part, an elastic element and a blocking section, the blocking section is movably disposed at the locking part, the elastic element is disposed between the locking part and the blocking section, and the blocking section cooperates with the elastic element to apply an elastic pressure to an engaged object.

2. The fastening body according to claim 1, further comprising a fastener, the locking part is fastened with the fastener.

3. The fastening body according to claim 1, wherein the locking part is provided with a limiting part, the limiting part is used to limit a position with the blocking section, or the locking part is fastened with a fastener and limits a position by the limiting part, or a width of the limiting part is wider than or equal to a width of the locking part, or the width of the limiting part is wider than a width of a corresponding abutting part of the blocking section.

4. The fastening body according to claim 1, wherein the locking part is provided with a restriction part, the restriction part is used to combine with a fastener.

5. The fastening body according to claim 1, wherein the blocking section and an object or a fastener therebetween have a reserved height, the engaged object is fastened into, entering or squeezed into the locking part from the reserved height, the blocking section is used to apply an elastic pressure to the engaged object; or the blocking section and an object or a fastener therebetween have a reserved height, after the engaged object is fastened into, entering or squeezed into the locking part from the reserved height, the reserved height is lowered or a height of the locking part is lowered, the blocking section is used to apply an elastic pressure to the engaged object.

6. The fastening body according to claim 1, wherein the engaged object is provided with an entry portion and an engagement portion communicated with each other, the fastening body enters the engagement portion from the entry portion, or the blocking section elastically contacts to the engaged object, and then the locking part fastens with a fastener, so that the blocking section applies an elastic pressure to the engaged object.

7. The fastening body according to claim 2, wherein the fastener is provided with an assembling portion, the assembling portion is assembled to an object, or the assembling portion is for soldering, fastening, riveting, expanding, locking, or bonding to an object.

8. The fastening body according to claim 1, wherein the fastening body is assembled to an object, so that the blocking section cooperates with the elastic element to apply an elastic pressure greater than or equal to an elastic stroke of a thickness of a limiting part of the locking part to the engaged object.

9. The fastening body according to claim 1, wherein the blocking section is a fastener, the fastener is used to fasten to the engaged object, or the blocking section is provided with a fastener, the fastener is used to fasten to the engaged object.

10. The fastening body according to claim 1, wherein the locking part is provided with a locking part assembling portion, the locking part assembling portion is assembled to an object, the locking part assembling portion is provided with a first anti-rotation part, the object is provided with an object anti-rotation part, the first anti-rotation part and the object anti-rotation part are anti-rotated or limited to each other, or for limiting a fastening direction of the locking part assembling portion or for limiting a fastening direction of the blocking section.

11. The fastening body according to claim 1, wherein the locking part is provided with a locking part assembling portion, the locking part assembling portion is assembled to an object, wherein the locking part assembling portion has a material entry portion to make the material of the object flow into or enter the material entry portion when the locking part applies pressure to the object, or the locking part assembling portion has an expanding portion for expanding and connecting to the object, or the locking part assembling portion has a solderable surface for soldering to the object, or the locking part assembling portion has a locking part for fastening to the object, or the locking part assembling portion has a screw thread for screw fastening to the object.

12. The fastening body according to claim 1, wherein the locking part is provided with a second anti-rotation part, the blocking section is provided with a blocking section anti-rotation part, the second anti-rotation part and the blocking section anti-rotation part are anti-rotated or limited to each other, or for limiting the fastening direction of the blocking section.

13. The fastening body according to claim 1, wherein the blocking section is used to rotate after resisting an elastic movement of the elastic element by an engaged object, or the blocking section rotates after resisting an elastic movement of the elastic element, so that the blocking section is fastened or pressed to the engaged object.

14. The fastening body according to claim 1, wherein the blocking section is provided with a blocking section limiting part, the engaged object has an engaged object limiting part docking with the blocking section limiting part.

15. The fastening body according to claim 1, wherein the fastening body is assembled to an object, so that the blocking section cooperates with the elastic element to apply an elastic pressure equal to or greater than an elastic stroke of a thickness of the blocking section to the engaged object, or the blocking section cooperates with the elastic element to apply an elastic pressure equal to or greater than an elastic stroke of a thickness of a limiting part of the locking part to the engaged object, or the blocking section cooperates with the elastic element to apply an elastic pressure equal to or greater than an elastic stroke of a thickness of the blocking section or plus a thickness of a limiting part of the locking part to the engaged object.
